(19) United States
(12) Patent Application Publication
(10) Pub. No.: US 2017/0156962 A1
(43) Pub. Date: Jun. 8, 2017

(54) LUMBAR ALIGNING MOVEMENT ASSISTING DEVICE

(71) Applicant: Kwang Bok EUM, Busan (KR)

(72) Inventor: Kwang Bok EUM, Busan (KR)

(21) Appl. No.: 15/439,942

(22) Filed: Feb. 23, 2017

Related U.S. Application Data
(63) Continuation of application No. PCT/KR2015/014210, filed on Dec. 23, 2015.

(30) Foreign Application Priority Data
Dec. 24, 2014 (KR) 10-2014-0188928

(51) Int. Cl. A61H 1/02; A61H 39/04; A63B 23/02; A61H 1/00

(52) U.S. Cl. CPC A61H 1/0292; A61H 1/005; A61H 39/04; A63B 23/0238; A61H 2201/1261; A61H 2201/1695; A61H 2201/1671; A61H 2201/1626

(57) ABSTRACT

The present invention relates to a lumbar aligning movement assisting device and, more particularly, to a lumbar aligning movement assisting device including a body formed as a cylinder and having acupressure rods capable of revolving, wherein a user can use one's own body to subject the lumbar region to acupressure and relax the muscles in order to strengthen the muscles, and can stretch the lumbar region so as to have the effect of a traction exercise of the lumbar vertebrae.

### CROSS-REFERENCES TO RELATED APPLICATIONS

This application claims the benefit of priority and is a Continuation application of the prior International Patent Application No. PCT/KR2015/014210, with an international filing date of Dec. 23, 2015, which designated the United States, and is related to the Korean Patent Application No. 10-2014-0188928, filed Dec. 24, 2014, the entire disclosures of all applications are expressly incorporated by reference in their entirety herein.

### BACKGROUND OF THE INVENTION

1. Field of the Invention

The present invention relates to a lumbar aligning movement assisting device, and more particularly, to a lumbar aligning movement assisting device which is capable of strengthening muscles by practicing acupressure on a lumbar region of a user's body to relax the muscles himself or herself by using a cylindrical rotatable body including acupressure rods and is capable of exhibiting an effect of a traction exercise of lumbar vertebrae by straightening the lumbar region.

2. Description of Related Art

In general, the lumbar vertebrae is a region between thoracic vertebrae which is backbone and sacrum which is sacral vertebrae, and is a bone structure constituting the waist. The lumbar vertebrae of a person includes five bones, and has a function of supporting the body and maintaining person's balance through ligaments and muscles. The lumbar vertebrae has a normal shape such that a front and rear curvature from the cervical vertebrae to the caudal vertebrae has an appropriate angle when viewed from the side. Thus, a weight is distributed so as not to cause the person's body to overstrain, and the person can maintain their posture by maintaining their balance. However, a wrong posture or an accident causes a spinal disc disorder called a disc disorder that comes with a severe ache due to deformation or stenosis of a curve of the lumbar vertebrae.

Particularly, since many people work long hours while remaining seated, spinal disk disorders have been rapidly increased, and such disorders have become a social problem. Such disorders need to be mostly managed by using an assisting device having a function of practicing acupressure, exercising, and massaging a patient′ aching region for several months to several years except for a disorder requiring surgery.

As the above-mentioned assisting device, a roller-pressure treatment device is described in Korean Patent Publication No. 2002-0058123 (publication date: Jul. 12, 2002). Particularly, the roller-pressure treatment device is capable of automatically practicing acupressure treatment on a patient's spinal region while the patient sits in a comfortable position by allowing a user to lie down and causing roller-pressures to vertically move in reciprocating motion by using a motor as a driving source. Further, the roller-pressure treatment device is capable of previously preventing complaint of pain caused by immoderate acupressure by providing the pressures as a plurality of rotation rollers. Furthermore, the roller-pressure treatment device is capable of aligning the patient's spinal region and maximizing an acupressure treatment effect by allowing a guide rail to laterally move in reciprocating motion and vertically move along a curve of the human body.

As the above-mentioned assisting device, backbone sporting equipment is described in Korea Patent Registration No. 10-1048720 (registration date: Jul. 6, 2011). Support pipes formed so as to support the user's spinal region while the user comfortably lies down are provided in the backbone sporting equipment, and the support pipes are mount on a movement member layered on a roller accommodated in a guide rail to laterally move. Further, the support pipes pressurize regions around the spinal region located in spaces between the support pipes, and thus, the backbone sporting equipment has a function of aligning and physical treatments on the cervical vertebrae.

However, the related arts may be used as sporting equipment capable of enabling the user to exercise their entire spinal region in a wide range, but there are limitations of intensive exercise of the lumbar vertebrae. Particularly, the disorders such as spinal disc extrusion which appear in the lumbar vertebrae and are related to the stenosis of the lumbar vertebrae may be cured through the acupressure such as massage. However, a method of curing the lumbar vertebrae by straightening the lumbar vertebrae through exercise walking and traction exercise as most effective kinesiotherapy has been widely used, but there is a problem that the related arts are not effective for curing the lumbar vertebrae through the traction exercise of the lumbar vertebrae.

### BRIEF SUMMARY OF THE INVENTION

Accordingly, the present invention has been made in order to solve the problems of the related art, and it is an object of the present invention to provide a lumbar aligning movement assisting device which is capable of strengthening muscles by practicing acupressure on a lumbar region of a user's body to relax the muscles himself or herself by using a cylindrical rotatable body including acupressure rods and is capable of exhibiting an effect of a traction exercise of lumbar vertebrae by straightening the lumbar region.

Accordingly, in order to achieve the above-described object, a lumbar aligning movement assisting device according to the present invention includes: a body that includes a plurality of acupressure rods which relaxes muscles around a lumbar vertebrae, and circular plates which are fastened to both side ends of the acupressure rods; fixation plates that are coupled to the circular plates of the body, and include rotation units therein so as to rotate the body; legs that extend from centers on outer sides of the fixation plates, and are bent in a direct downward direction; and front supports and rear supports that extend from lower ends of the legs in forward and rearward directions, and support the legs on a bottom.

Portions of the acupressure rods of the body in contact with a body in an outer direction of the circular plates may be formed as a curved surface, and the entire shape of the acupressure rods may have an elliptical shape.

The rotation unit may include a ring-shaped rail inside the fixation plate, and may include a plurality of rotation balls accommodated in the ring-shaped rail.

The fixation plate may include a projection that protrudes inwards, the projection penetrates the circular plate, and a fastening bracket may be fastened to an end of the projection.

The leg may include penetrating holes which are vertically arranged on both side surfaces, and the lumbar aligning movement assisting device may further include fixation pins fastened to the penetrating holes so as to adjust a vertical height of the leg.

The lumbar aligning movement assisting device may further include: rubber pads that are respectively provided at lower ends of the front supports and the rear supports so as to prevent the legs from being arbitrarily moved.

A conduction prevention plate may be vertically coupled between lower ends of the legs and the rear supports so as to prevent conduction.

Casters may be further provided at the lower ends of the front supports and the rear supports, and a stopper may be provided on one side of the caster.

In accordance with the lumbar aligning movement assisting device according to the present invention described above, there are effects that the device can have various heights depending on a height of a user by adjusting the height of the legs and it is possible to prevent the user from being additionally wounded by conduction by preventing a conduction phenomenon.

Particularly, since the user actively moves upwards and downwards while the user stands straight and the lumbar region of the user leans against the device, there are effects that it is possible to strengthen muscles by stretching the muscles around the lumbar vertebrae and it is possible to take a traction exercise of the lumbar vertebrae by straightening the muscles around the muscles the lumbar vertebrae. The user can use the lumbar aligning movement assisting device for lumbar aligning and curing. There is an effect that the height of the user is increased by using the lumbar aligning movement assisting device for orthotherapy exercises, and there is an effect that the lower body of the user is trained through the active movement.

### BRIEF DESCRIPTION OF THE DRAWINGS

FIG. 1 is a perspective view of a lumbar aligning movement assisting device according to a preferred embodiment of the present invention.

FIG. 2 is an exploded perspective view of the lumbar aligning movement assisting device according to the preferred embodiment of the present invention.

FIG. 3 is a perspective sectional view of the lumbar aligning movement assisting device according to the preferred embodiment of the present invention.

FIG. 4 is a sectional view of the lumbar aligning movement assisting device according to the preferred embodiment of the present invention.

FIG. 5 is a partial perspective view of the lumbar aligning movement assisting device according to the preferred embodiment of the present invention.

FIG. 6 is a diagram showing a state in which the lumbar aligning movement assisting device according to the preferred embodiment of the present invention is used.

### DETAILED DESCRIPTION OF THE INVENTION

Hereinafter, a preferred embodiment of the present invention will be described in detail with reference to the accompanying drawings. However, the present invention may be implemented in various different forms in the following description, and is not limited to an embodiment mentioned herein. Through the drawings, the same components will be assigned the same reference numerals.

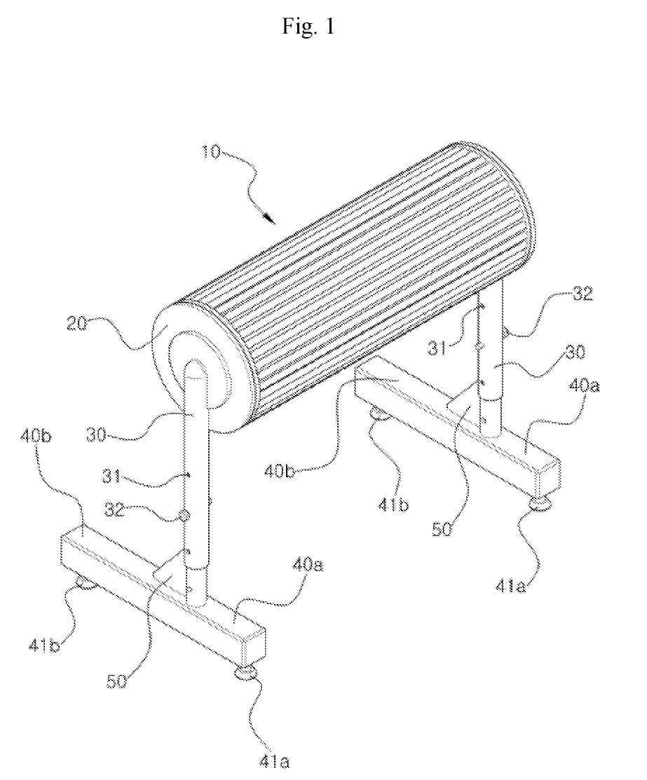

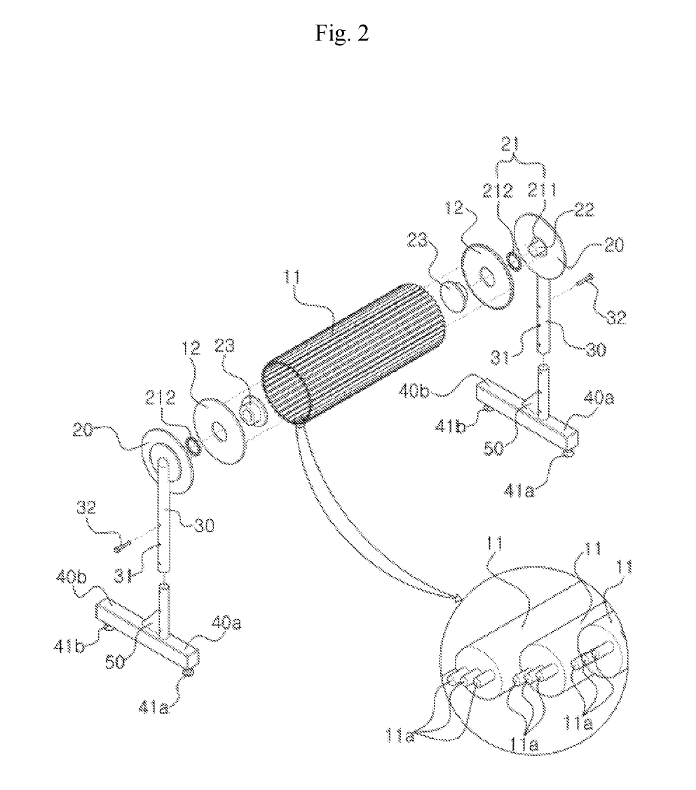

Initially, FIG. 1 is a perspective view of a lumbar aligning movement assisting device according to the preferred embodiment of the present invention, and FIG. 2 is an exploded perspective view of the lumbar aligning movement assisting device according to the preferred embodiment of the present invention.

As shown in FIGS. 1 and 2, a lumbar aligning movement assisting device 100 according to the embodiment of the present invention primarily includes a body 10 that massages a lumbar region of the body, fixation plates 20 that respectively include rotation units 21 that are coupled to the body and rotate the body, legs 30 that respectively extend from centers of the fixation plates 20 and are bent in a direct downward direction, and supports 40 that are respectively coupled to lower ends of the legs 30 so as to support the legs 30 on a bottom.

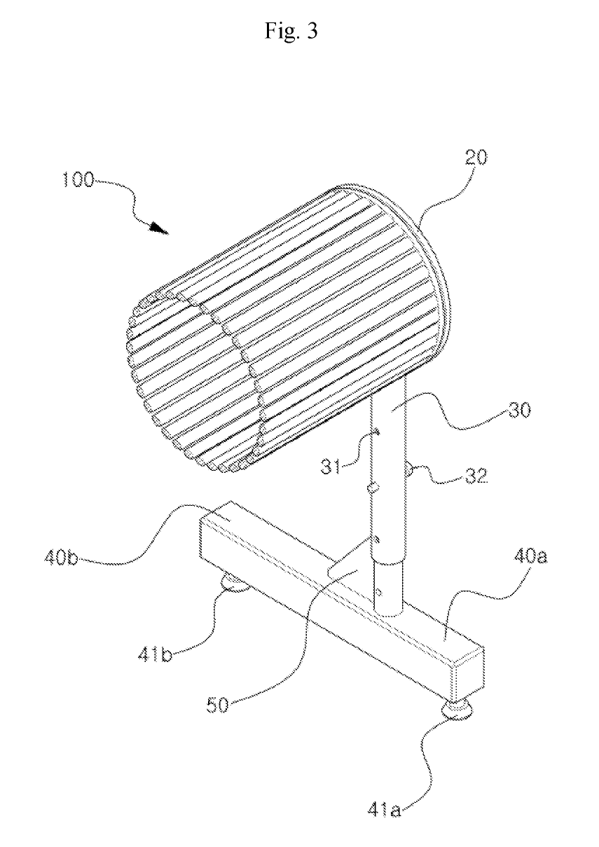

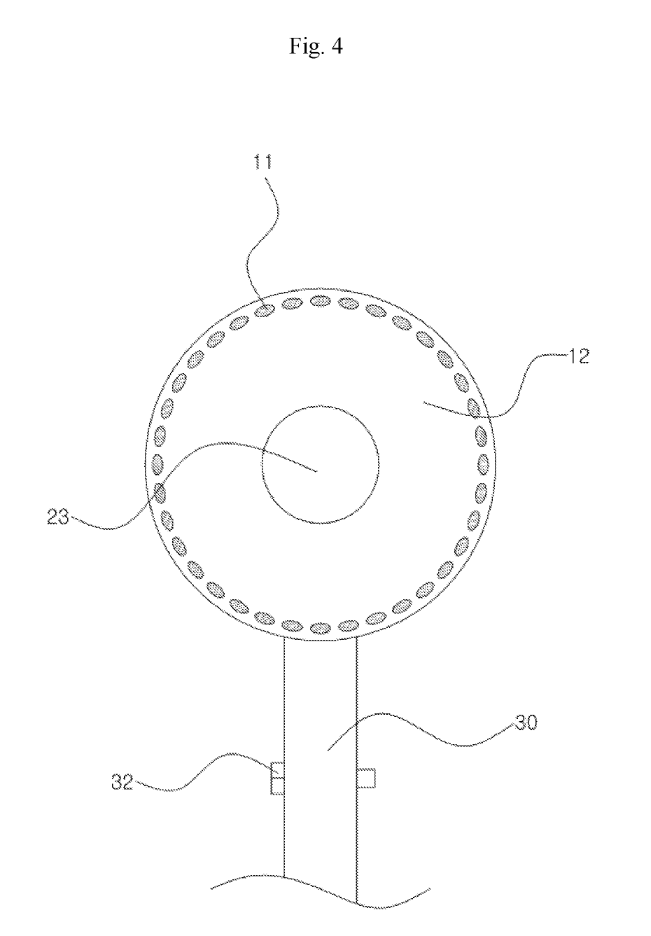

Hereinafter, the respective components will be described in more detail. The body 10 includes a plurality of acupressure rods 11 that is capable of loosening and straightening muscles of the lumbar region. Here, the acupressure rod 11 has a cylinder shape having a diameter of 20 mm to 40 mm so as to correspond to a size of vertebral column corresponding to lumbar vertebrae of the body in a longitudinal direction. A portion of the acupressure rod in contact with the body is formed as a smoothly curved surface, and the entire shape of the acupressure rods preferably has an elliptical shape. Both side ends of the acupressure rod 11 are coupled to circular plates 12. Here, as shown in FIGS. 3 and 4, the plurality of acupressure rods 11 is arranged in a circular shape so as to correspond to circumferences of the circular plates 12, and is coupled to the circular plates. Preferably, a distance between the acupressure rods is 10 mm to 20 mm so as to practice acupressure between the respective regions of the lumber lumbar vertebrae. Preferably, a diameter of the circular plate 12 is 200 mm to 500 mm so as to have a size corresponding to the lumbar region of the body.

Meanwhile, the curved surface of the acupressure rod is provided so as to face the outside, and insertion pieces 11a formed at both side ends of the acupressure rod 11 are preferably coupled to the circular plates. As a fixation method, a volt coupling method using a bolt or a bonding method may be used, and the volt coupling method is preferably used in order to prevent a user from being wounded.

The fixation plate 20 is configured such that the body 10 is able to be rotated, and includes the rotation unit 21 that is coupled to the circular plates 12 of the body 10 within the circular plates 12 so as to rotate the body 10. Here, the rotation unit 21 includes a ring-shaped rail 211 having a predetermined width in a central portion within the circular plate 12 so as to rotate the body 10 within the circular plate, and are provided with a plurality of rotation balls 212 at the ring-shaped rail 211.

Here, the plurality of rotation balls 212 has a globular shape, and is accommodated in the ring-shaped rail 211. The rotation balls roll along the ring-shaped rail 211 on the circular plate 12 in contact with the rotation ball 212, the circular plate 12 is rotated, and the body 10 is rotated.

Meanwhile, a projection 22 that protrudes from the inside of the fixation plate 20 toward the circular plate 20 in the drawing is provided between the fixation plate 20 and the circular plate 12. The projection 22 penetrates a center of the circular plate 12, a fastening bracket 23 is fastened to an end of the projection 22, and the circular plate 12 is fixed to the fixation plate 20.

The legs 30 are vertically provided such that the body 10 and the fixation plate 20 are located so as to be separated from the ground by a predetermined distance, extend from a center on an outer side of the fixation plate 20, and are bent in the direct downward direction.

Here, the leg 30 may include penetrating holes 31 vertically arranged on both side surfaces, and may further include fixation pins 32 fastened into the penetrating holes 31 so as to adjust a vertical height of the leg. Preferably, a pair of upper and lower legs 30 is provided, and the legs may be fixed by the fixation pins 32 fastened into the formed penetrating holes when the pair of upper and lower legs is coupled. By doing this, there is an effect that the device can have various heights depending on the height of the user by adjusting the height of the legs 30.

The support 40 includes a front support 40a that extends forwards and a rear support 40b that extends rearwards so as to support the leg 30 on the bottom. The forward and rear supports respectively extend from lower ends of the legs 30 in forward and rearward directions so as to support the legs 30 on the bottom, and are integrally formed. Here, the rear support 40b that extends rearwards is formed such that a length thereof in the longitudinal direction is longer than that of the front support 40a, and has stability against force applied to in a lower diagonal direction in the rearward direction when the user uses the lumbar aligning movement assisting device 100 of the present invention.

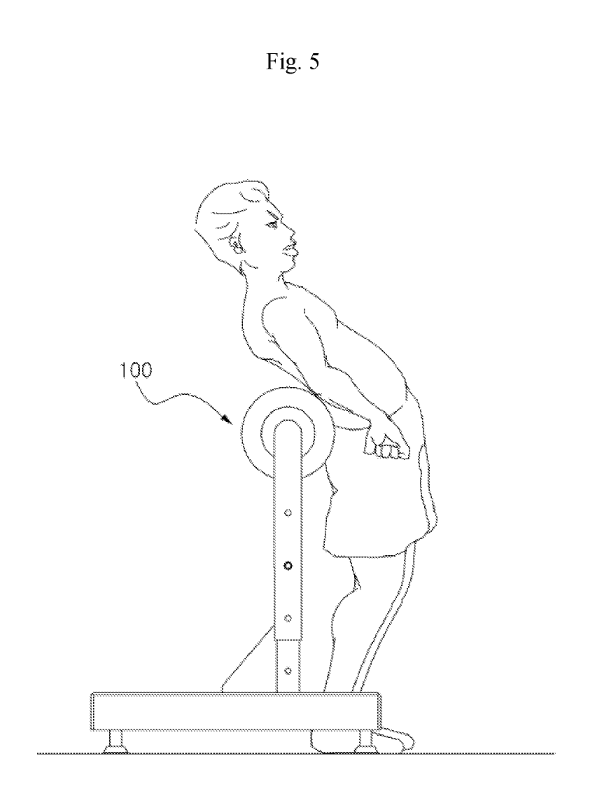

Rubber pads 41a and 41b may be further provided at the lower ends of the front support 40a and the rear support 40b so as to prevent the supports from being arbitrarily moved, and casters 42a and 42b provided with stoppers 421 may be provided at the lower ends of the front support 40a and the rear support 40b so as to provide driving force (FIG. 5).

Here, the casters 42a and 42b are used for allowing the user to easily store and use the lumbar aligning movement assisting device 100 of the present invention, and the user can move the device with less force. Meanwhile, the casters 42a and 42b are provided with the stoppers 421, and prevent the device from being unnecessarily moved when the user uses the lumbar aligning movement assisting device 100 of the present invention. Here, the stoppers 421 are preferably fixed by the treading of the user, and the stoppers 421 are preferably configured so as to directly fix wheels.

A conduction prevention plate 50 may be vertically provided between the lower end of the leg 30 and the rear support 40b so as to prevent conduction of the lumbar aligning movement assisting device 100 of the present invention. As stated above, there is an effect that it is possible to prevent the user from being additionally wounded by the conduction by preventing a conduction phenomenon by using the conduction prevention plate 50.

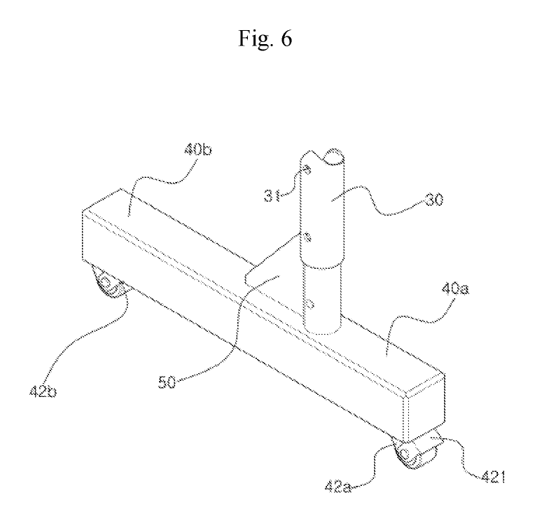

FIG. 6 is a diagram for showing a state in which the lumbar aligning movement assisting device according to the preferred embodiment of the present invention is used. As shown in the drawing, according to the lumbar aligning movement assisting device 100 of the present invention, the user actively moves upwards and downwards while the user stands straight and the lumbar region of the user leans against the body 10. Thus, there are effects that it is possible to strengthen the muscles by stretching the muscles around the lumbar vertebrae and it is possible to take a traction exercise of the lumbar vertebrae by straightening the muscles of the lumbar region. The user can use the lumbar aligning movement assisting device 100 of the present invention for lumbar aligning and curing. Further, there is an effect that the height of the user is increased by using the lumbar aligning movement assisting device for orthotherapy exercises, and there is an effect that the lower body of the user is trained through the active movement.

Although the present invention described above has been described in conjunction with the embodiment illustrated in the drawing, the present invention is merely an example, and various modification and other equivalent embodiments may be derived by those skilled in the art. It should be interpreted that all technical ideals within an equivalent scope are included in the right scope of the present invention.

What is claimed is:

1. A lumbar aligning movement assisting device comprising:
a body that includes a plurality of acupressure rods which relaxes muscles around a lumbar vertebrae, and circular plates which are fastened to both side ends of the acupressure rods;
fixation plates that are coupled to the circular plates of the body, and include rotation units therein so as to rotate the body;
legs that extend from centers on outer sides of the fixation plates, and are bent in a direct downward direction; and
front supports and rear supports that extend from lower ends of the legs in forward and rearward directions, and support the legs on a bottom.

2. The lumbar aligning movement assisting device according to claim 1,
wherein portions of the acupressure rods of the body in contact with a body in an outer direction of the circular plates are formed as a curved surface, and the entire shape of the acupressure rods has an elliptical shape.

3. The lumbar aligning movement assisting device according to claim 1,
wherein the rotation unit includes a ring-shaped rail inside the fixation plate, and includes a plurality of rotation balls accommodated in the ring-shaped rail.

4. The lumbar aligning movement assisting device according to claim 1,
wherein the fixation plate includes a projection that protrudes inwards, the projection penetrates the circular plate, and a fastening bracket is fastened to an end of the projection.

5. The lumbar aligning movement assisting device according to claim 2,
wherein the fixation plate includes a projection that protrudes inwards, the projection penetrates the circular plate, and a fastening bracket is fastened to an end of the projection.

6. The lumbar aligning movement assisting device according to claim 3,
wherein the fixation plate includes a projection that protrudes inwards, the projection penetrates the circular plate, and a fastening bracket is fastened to an end of the projection.

7. The lumbar aligning movement assisting device according to claim 1,
wherein the leg includes penetrating holes which are vertically arranged on both side surfaces, and
the lumbar aligning movement assisting device further includes fixation pins fastened to the penetrating holes so as to adjust a vertical height of the leg.

8. The lumbar aligning movement assisting device according to claim 1, further comprising:
rubber pads that are respectively provided at lower ends of the front supports and the rear supports so as to prevent the legs from being arbitrarily moved.

9. The lumbar aligning movement assisting device according to claim 1,
wherein a conduction prevention plate is vertically coupled between lower ends of the legs and the rear supports so as to prevent conduction.

10. The lumbar aligning movement assisting device according to claim 1,
wherein casters are further provided at the lower ends of the front supports and the rear supports, and a stopper is provided on one side of the caster.
